(19) United States
(12) Patent Application Publication
(10) Pub. No.: US 2014/0250847 A1
(43) Pub. Date: Sep. 11, 2014

(54) Wire Mesh Filter with Improved Wire and Method of Making the Wire

(71) Applicants: Kurry Emmons, Neshanic Station, NJ (US); Domingo Santana, Perth Amboy, NJ (US)

(72) Inventors: Kurry Emmons, Neshanic Station, NJ (US); Domingo Santana, Perth Amboy, NJ (US)

(73) Assignee: Metal Textiles Corporation, Edison, NJ (US)

(21) Appl. No.: 14/200,167

(22) Filed: Mar. 7, 2014

Related U.S. Application Data
(60) Provisional application No. 61/774,685, filed on Mar. 8, 2013.

(51) Int. Cl. B01D 39/20

(52) U.S. Cl. CPC B01D 39/2041
USPC 55/526; 428/603; 140/149

(57) ABSTRACT

A filter for use in safety air bags as employed in vehicles and the like comprises compressed corrugated wire wherein the corrugations are formed as a periodic sequence of substantially identical first sinusoidal waves coplanar in one orientation of a first given amplitude and pitch and a periodic sequence of substantially identical second sinusoidal waves of a second amplitude and pitch different than the first given amplitude and pitch oriented orthogonal to the plane of the first waves to form a wire with complex three dimensional waves. The wires so formed are wrapped about a mandrel in multiple layers and the ring so formed distorted into an oval shape that is inserted into a filter forming die. A plunger then is forced under high pressure into the die to form the compressed wire filter. The layers of undulations of the wire interlock to preclude separation of the compressed layers during deployment of an air bag.

Priority is claimed on provisional application Ser. No. 61/774,685 filed Mar. 8, 2013, incorporated by reference in its entirety herein.

This invention relates to compressed wire mesh filters for filtering hot gases generated by the deployment of automotive air bags, to the wire employed in the filter and to the method for making the wire.

Automotive air bags are in wide use and which form a passive restraint system to enhance passenger safety in automobiles and other vehicles or modes of transportation. Air bags comprise a bag or similar bladder that is inflated in short time periods using compressed or chemically generated gas using relatively high gas pressures, e.g., 20-30 MPa (MPa=145 psi), and temperatures. Such gases may have a known composition, for example, as disclosed in U.S. Pat. No. 5,525,170, incorporated by reference herein. These gases generate an explosive force that the filter needs to stabilize. As these generated forces increase with newer units, the filter needs to withstand such greater forces. Such filters are intended to remove burning particles of the gas propellant ignited to inflate the air bag. Depending upon the application, the generated pressure can be applied for a relatively short duration, e.g., milliseconds. Such forces may distort or otherwise deform the filter, decreasing its effectiveness.

In some filter designs, the hoop strength of the filter is critical. For example, see U.S. Pat. No. 6,277,166, incorporated by reference herein, wherein the wire mesh filter is formed with ribs extending outwardly from the filter to increase the hoop strength of the filter. Also, see U.S. Pat. No. 7,559,146, incorporated by reference herein, which also provides a solution to the hoop strength of such filters by providing at least one hoop wire around the exterior of the filter interlocked with the wire mesh when the filter is compression molded. However, the filter shown in U.S. Pat. No. 7,559,146 is formed of wires knitted into a tubular arrangement. The knitted wire tube is then molded in a hardened steel mold as described in this patent. While this design of the tube using knitted wires exhibits a problem with hoop strength to which this patent is directed, there are other designs of air bag filters that do not have such problems.

Also, the knitted wire tubular designed filters have other problems. For example, the knitted tubes have been used for filter manufacture for many decades. The problem with such knitted wire tubes is commonly referred to as “chips.”

Because the knitted wire mesh is made by interlocking omega shaped loops, when the continuous length mesh tube is cut, many half loops or “U-shaped chips” remain dangling on the cut edge of the mesh. These chips can potentially fall off in service creating many problems In an air bag application, i.e., the loose chips can be blown off during the inflation event, and burn through the bag, injuring an occupant. The prior art recognizes this problem and provides a solution by using a different kind of wires. The wires used in such filters comprise one or more continuous lengths of a given mass and corrugated with undulating coplanar sinusoidal waves in each wire. Filters of this design have been in use commercially for many years.

Such prior art filters with continuous one piece corrugated wires, are less costly to manufacture and thus are more competitive in the marketplace. However, wherein such less costly filters are formed with undulating sequence of substantially identical coplanar sinusoidal waves, the filters have a problem different than the hoop strength and chip problems of knitted wires. The problem with such corrugated steel wires is that the layers of the molded compressed length of wire forming the filter tend to separate under tensile forces, i.e., in response to explosive pressures of the air bag deployment gases, not present in the knitted wire filters. The present inventors have identified the cause of the wire separation problem in such filters and have recognized the solution of this problem.

Thus, when exposed to the explosive forces in an air bag environment, prior art filters of the continuous wires with corrugated waves exhibit problems addressed by the present invention. FIGS. 1 and 2 illustrate one such prior art compressed wire filter using a wire with coplanar undulating waves. The filter 2 is formed with a wire that exhibits substantially sinusoidal waves that are coplanar. The prior art filter 2 comprises a pre-shaped configured corrugated wire 4 shown in FIGS. 8 and 9. The configured corrugated wire 4 comprises a coplanar sequence of substantially identical sinusoidal waves 6. Such waves 6 may have an exemplary pitch of about 8 mm and an exemplary amplitude of about 4.5 mm. These values may range from generally about 3 to 14 mm for the pitch and generally from about 1 to 10 mm for the amplitude. The specific values depend upon the design and dimensions of a given product and could differ from the ranges given depending upon a given implementation.

The wire 4 is formed by passing a length of suitable prior art steel wire 8, FIG. 10, which could be 50 feet (30.5 cm/foot) or more (or two or more multiple lengths of wires) which may be stainless steel, carbon steel or any other suitable metal wire of a known diameter or gage, as known in this art, through a pair of prior art rotating meshing helically grooved crimping rollers 10, 12. The wires, for example, may be about 0.5 to 0.7 mm in diameter and also can vary from 0.25 to 1.0 mm. The most common wire for air bag use is type 430 stainless steel (SS) or 1008/1010 carbon steel. Other applications may include high pressure fuel injector filters, using wires from about 0.1 mm to about 0.25 mm diameter using type 304 SS.

While helically grooved rollers are illustrated by way of example in this embodiment, rollers with parallel meshing grooves could also be used to create similar corrugations.

The waves 6 generally are identical as formed, but due to the resiliency of the wire during their formation by the rollers' 10, 12 wire deformation process, the waves of the formed wire may deviate somewhat from a given sinusoidal configuration. This is acceptable. Also, the waves 6, while generally coplanar, may also deviate somewhat from being coplanar due to their resiliency during formation, also acceptable.

A fixed predetermined mass of the crimped wire 4 is then cut. This mass may comprise one or more lengths of such wire. The wire 4 in the present embodiment has a length of about 60 feet (30 cm/ft) and a diameter of about 0.5 to about 1.0 mm, which is optional. Depending upon the size of the filter or wire OD, the length of wire may differ in different implementations according to a selected filter size. For example, the wires can be long such as 50 to 100 feet (15.2 to 30.4 meters) or short, such as 3 to 4 feet, depending upon wire diameter. The larger the wire diameter, e.g., 10 mm, the shorter the wire length, e.g., 3 to 4 feet. In airbag applications, the hot explosive gases during deployment may burn very fine wire, but this acceptable, because the burning time in this environment is a relatively short event.

The so formed fixed mass of coplanar sinusoidal shaped wire 4 (or wires) is wrapped about a cylindrical mandrel such as mandrel 14, FIG. 13, shown in FIG. 13 only for illustration purposes as to the wire 4 (not shown in this figure). This action creates a cylindrical mass of wrapped wire 4. In FIG. 14, it should be understood, the wire shown wrapped about the mandrel 14 is the inventive wire 36, FIGS. 5, 6 and 7, to be described in the detailed description below. The wire 36, as recognized by the present inventors, solves the above described problem of separation of the layers in response to tensile forces applied to such filters, e.g., the forces of bag deployment. This wire 36 may have the same diameter as the prior art wire discussed in introductory portion and also the wire may have a diameter of about 0.1 mm to about 1 mm.

Generally, the wrapped wire 36 of FIG. 14 may represent the prior art wire 4 (not shown in this figure) as well, both of which wires are wrapped about the mandrel 14 similarly to form a cylinder of wrapped wire. The mandrel 14 may preferably be about 3.5 inches (8.9 cm) in diameter in one embodiment and may differ according to a given implementation. The wrapped wire forms a ring such as illustrated in FIG. 13.

The so formed ring after removal from the mandrel is crushed to form an oval shape such as shown in FIG. 14. This figure illustrates the novel inventive wire 36 to be described in the detailed description of the invention below, which wire may also generally represent wire 4 (not shown in this figure) of the prior art filter 2. The oval shaped ring of prior art wire 4 is then placed in a prior art forming tool 16, FIG. 15. While the ring is crushed to form an oval, this is optional. The ring as a cylinder may also be placed in the forming tool such as tool 16. The ring is crushed as a large amount of wire is being placed in a relatively small space in the tool. The oval shape making it easier to assemble the ring into the tool because of the ring's mass. Smaller masses need not be crushed into an oval shape.

The tool 16, FIGS. 15, 15a, 15b and 15c, comprises hardened tool steel. Tool 16 has an outer cylindrical die 18 having a central cylindrical bore 20. A separate cylindrical mandrel 22, FIG. 15a, has an elongated cylindrical rod-like mandrel portion 32 which mates with the bore 20, FIG. 15b. The mandrel 22 has a bottom cylindrical flange 28 with a stepped up inner cylindrical shoulder 30. Mandrel portion 32 extends upstanding from the shoulder 30 inside the bore 20 of the die 18.

In FIGS. 15, 15b and 15c, cylindrical plunger 34 has a central through bore 35 for receiving the mandrel portion 32. The plunger 34 has a raised central cylindrical shoulder 37 at one end and is flat or rounded at its other opposite end 38. Plunger 34 is inserted into the die 16 bore 20 forming cavity 42 in which the filter 2 is formed. The filter is formed by compression and crush molding under high pressure (e.g., 200 to 400 MPa) the oval ring placed inside the bore 20 and adjacent to the mandrel portion 32, as illustrated by FIG. 16, showing the inventive wire 36 and not the prior art wire 4 for illustration. The mandrel 22 and crushed wire oval ring of prior art wire 4 is inserted in the bore 20, similar to that illustrated in FIG. 17 showing the inventive crushed oval ring of inventive wire 36.

In FIGS. 1 and 2, prior art filter 2 is formed from the wires 4 crushed and molded in die 16 as described. The filter 2 has a recessed inner shoulder 24 in communication with the filter central cylindrical through bore 26 and terminates internal ID wall 27. Shoulder 24 is formed by shoulder 37 of the plunger 34, FIG. 15c. The filter has a second shoulder 25, FIG. 2, formed by the shoulder 30 of the mandrel 22, FIG. 15a. The shoulders 24 and 25 face opposing sides of the filter and are both in communication with central through bore 26. The bore 26 is formed by the mandrel portion 32. The filter 2 is formed by the high pressure applied to the plunger 34, FIG. 17 against the preformed wire 36 formed as shown, for example, in the inventive embodiment of FIGS. 13 and 14. The filter has a predetermined mass and density corresponding to the amount of wire 4 employed. The filter of FIGS. 1 and 2 exhibits the problem of separation of the wire layers as noted hereinabove.

The present inventors recognize that the cause of the problem with the aforementioned filter with the wrapped corrugated wire of coplanar sinusoidal waves as shown in FIGS. 13 and 14 for the wire 36 of the present embodiment is that the wires 4 and 44 of the prior art filter are not sufficiently interlocked with each other when the filter is formed as shown in FIG. 17 for the filter 46 of the present embodiment. See for example the enlarged sectional views of the prior art filter and the filter according to an embodiment of the present invention as shown in FIG. 18a through FIG. 21c showing the difference in layering of the wires relative to each other such that the wires of the embodiment of the present invention are more interlocked with each other than the wires of the prior art filter. As a result of such a condition of the crushed wire layers of the prior art wire, the layers of the prior art filter 2 separate during use of an expanding air bag permitting unacceptable gases and contaminants to pass through the filter into the adjacent cabin during deployment of the air bag.

The above problems with the prior art are substantially resolved by the filter according to an embodiment of the present invention as best seen in the graph of FIG. 22 showing the difference in hoop strength of the two filters. According to an embodiment of the present invention, a length of metal wire for forming a compressed wire mesh annular filter comprises a first sequence of undulations extending along the wire length in a given direction generally lying in a first given plane and a second sequence of undulations extending along the wire length in the given direction generally lying in a second given plane transverse the first given plane. The wire is for being wrapped about itself to form a ring which, when shaped and compressed, forms the filter with contiguous adjacent compressed undulations, the compressed undulations, being distorted from their respective planes, tending to interlock to thereby preclude separation of adjacent wires that might otherwise occur in response to an applied load. In a further embodiment, the undulations comprise substantially sinusoidal waves.

In a further embodiment, a filter is formed with the aforementioned wire.

In a further embodiment, the first and second sequence of undulations are approximately orthogonal to each other.

In a further embodiment, the pitch of the first sequence of undulations of about 3.5 mm and amplitude of about 2 mm and the second sequence has a pitch of about 9 mm and amplitude of about 5 mm, the undulations forming sinusoidal waves, with the first and second sequences being approximately orthogonal to each other.

In a further embodiment, the undulations are sinusoidal and the pitch of the undulations range from about 3 to about 14 mm for either the first or second sequences and the amplitude of the undulations range from about 1 to 10 mm for either the first or second sequences.

In a further embodiment, the wires range from about 0.25 mm to about 1 mm diameter of at least one of stainless steel or carbon steel.

In a further embodiment, the wires are wrapped about one another to form an annular filter with adjacent undulations and at least a portion of the adjacent undulations are interlocked.

In a further embodiment, the filter is formed of the wire wrapped about itself forming multiple layers of crushed compressed wire.

In a further embodiment, the wire is one piece of a continuous length.

In a further embodiment, the filter comprises a plurality of the one piece continuous length wire.

In a further embodiment, the filter is a cylinder with an interior cylindrical bore, the cylinder having an outside diameter (OD) in the range of about 18 mm to about 70 mm, an interior bore having a diameter (ID) in the range of about 12 mm to about 60 mm and a height of about a 25 mm to about 50 mm.

In a further embodiment, the filter is a solid sphere of about 14 mm diameter and a solid cylinder of about 15 mm outside diameter and 10 mm in height.

In a further embodiment, a method of making a filter wire as aforementioned comprises passing a length of the wire in a first orientation between a first of two rotating rollers with meshing helical grooves to form the wire with the first sequence of undulations in substantially a first plane, rotating the length of wire to a second orientation, passing the rotated length of said wire in the second orientation between two further rotating rollers with meshing helical grooves to form the wire with the second sequence of undulations transverse to the first sequence of undulations.

In a further embodiment, the grooves of the first and further rollers have different pitches and depths to form the undulations with corresponding different pitches and amplitudes.

In a further embodiment, the pitch of the undulations range from about 3 to about 14 mm for either the first or further rollers and the amplitude of the undulations range from about 1 to about 10 mm for either the first or further rollers.

In a further embodiment, the undulations are sinusoidal and wherein the pitch and amplitudes of the first rollers differ from that of the further rollers.

In a further embodiment, the undulations are sinusoidal and the pitch of the undulations range from about 3 to about 14 mm for either the first or second sequences and the amplitude of the undulations range from about 1 to about 10 mm for either the first or second sequences.

In a further embodiment, the filter is one of a hollow cylinder with a central bore, a solid cylinder or a solid sphere.

In a further embodiment, the second orientation is orthogonal to the first orientation.

In a further embodiment, the method comprises wrapping a continuous one piece length of the wire about a mandrel to form a ring of multiple layers of the wire, crushing the wire into an oval shape, inserting the crushed oval shaped ring into a die, and then compressing the crushed oval shaped ring to form the filter.

In a further embodiment, the method includes forming the filter of a plurality of said length of wire.

In a further embodiment, the wire comprises a plurality of undulations extending in a plane and extending normal to that plane.

### IN THE DRAWING

FIGS. 1 and 2 are photographs of respective plan and side elevation views of a prior art filter made with a compressed continuous length of wrapped wire having coplanar sinusoidal undulations;

FIGS. 3 and 4 are photographs of respective plan and side elevation views of a filter according to an embodiment of the present invention made with a continuous length of wrapped wire having coplanar sinusoidal undulations oriented orthogonal to one another, wherein the undulations are interlocked in the compressed filter;

FIGS. 4a and 4b are respective side elevation views of a solid cylinder and a solid sphere according to further embodiments of the present invention;

FIG. 5 is a plan view of a portion of a wire fabricated according to an embodiment of the present invention used for forming the filter of FIGS. 3 and 4;

FIG. 6 is the side elevation view of the portion of the wire of FIG. 5;

FIG. 7 is an end elevation view of the wire of FIG. 5 taken at lines 7-7;

FIG. 8 is a side elevation view of a prior art wire used to make the filter of FIGS. 1 and 2 illustrating a substantially coplanar sequence of sinusoidal waves;

FIG. 9 is an end elevation view of the prior art wire of FIG. 8;

FIG. 10 is a photograph of two prior art meshed helically grooved rollers which are rotated to form prior art wire 4 exhibiting the sequence of sinusoidal waves from the commercially available continuous length of original wire 8;

FIG. 11 is a photograph of two prior art further rotating meshed helically grooved rollers of a different pitch and groove depth than the rollers of FIG. 10 for forming wire 36 according to the embodiment of the present invention from wire 4, FIG. 10;

FIG. 12 is a side elevation view of the rollers of FIG. 11 showing an end view of the wire 4 with the further corrugations being added forming wire 36.

FIG. 13 is a perspective photograph of the inventive wire 36 being wrapped about a mandrel tool to form the wrapped wire into a ring of wrapped layers of a continuous length of wire;

FIG. 14 illustrates the ring of wrapped wire of FIG. 13 crushed to form the ring into an oval shape for further processing into the final filter form;

FIG. 15 is an exploded perspective photographic view of a prior art tool comprising a die, a mandrel and a plunger used to form the final filter from the crushed oval shape of FIG. 14;

FIG. 15a is an isometric view of the mandrel of the tool of FIG. 15;

FIG. 15b is a cross sectional view of the tool of FIG. 15 with the mandrel and plunger assembled into the bore of the die illustrating the cavity in which the filter is formed;

FIG. 15c is an isometric view of the plunger of the tool of FIGS. 15 and 15b;

FIG. 16 is an isometric view of the tool of FIG. 15 with the mandrel partially inserted into the bore of the die and the crushed oval shape of wrapped wire engaged with the mandrel and partially inserted into the die bore;

FIG. 17 is a photograph exploded perspective view of the tool of FIG. 16 with the mandrel and engaged crushed oval shape of wrapped wire inserted into the bore of the die and the plunger aligned for final compression forming of the filter of FIGS. 3 and 4; and

FIGS. 18a, 18b and 18c are scanning electron microscope photographs of a prior art filter corresponding to the filter of FIGS. 1 and 2 at 20× magnification at different locations at a filter surface;

FIGS. 19a, 19b and 19c are scanning electron microscope photographs of a prior art filter at cut cross section regions of a filter corresponding to the filter of FIGS. 1 and 2 at 20× magnification at different locations at a filter surface;

FIGS. 20a, 20b and 20c are scanning electron microscope photographs of a filter according to the embodiment of the present invention corresponding to the filter of FIGS. 3 and 4 at 20× magnification at different locations at a filter surface;

FIGS. 21a, 21b and 21c are scanning electron microscope photographs of a prior art filter at cut cross section regions of a filter corresponding to the filter of FIGS. 1 and 2 at 20× magnification at different locations at a filter surface; and

FIG. 22 is a graph showing the hoop strength of a prior art filter corresponding to the filter of FIGS. 1 and 2 as compared to the hoop strength of a filter according to an embodiment of the present invention corresponding to the filter of FIGS. 3 and 4.

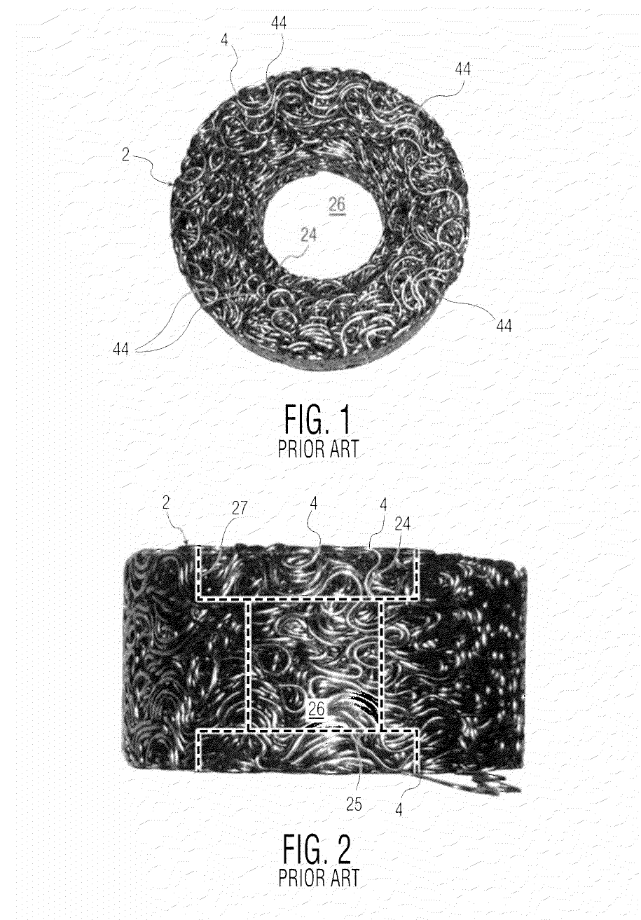

FIGS. 1 and 2 illustrate the prior art filter 2 formed with a continuous length of wire having a sequence of substantially sinusoidal waves of crushed continuous length of wire 4. The wire 4 is crushed into non-interlocked layers that tend to separate in the presence of a tensile or other similar loads during air bag deployment or the like. Such loads may be formed by the deployment forces when the air bag is blown up in response to explosive forces upon activation. The wires 4 exhibit the sinusoidal waves adjacent to one another in overlying non-interlocked layers. The waves typically form a nested layered relationship 44, rather than being interlocked. Such a nested layered relationship permits the layers of wires to easily separate permitting unwanted gas components to pass through the filter due to enlarged spaces between the wires created by the separations.

The wires, tool and methodology for forming the filter 2 are described in the introductory portion. The filter 2 has been commercially available for many years.

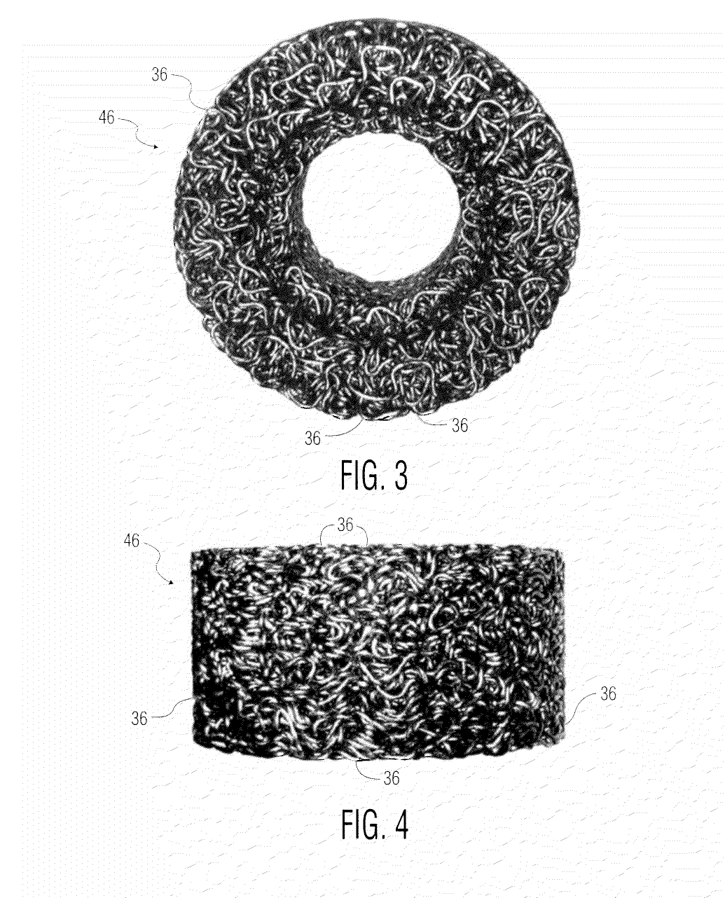

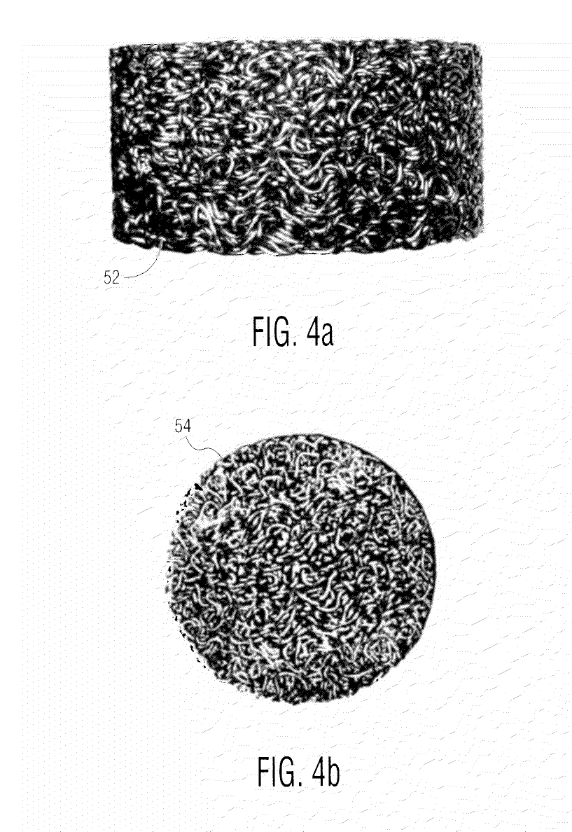

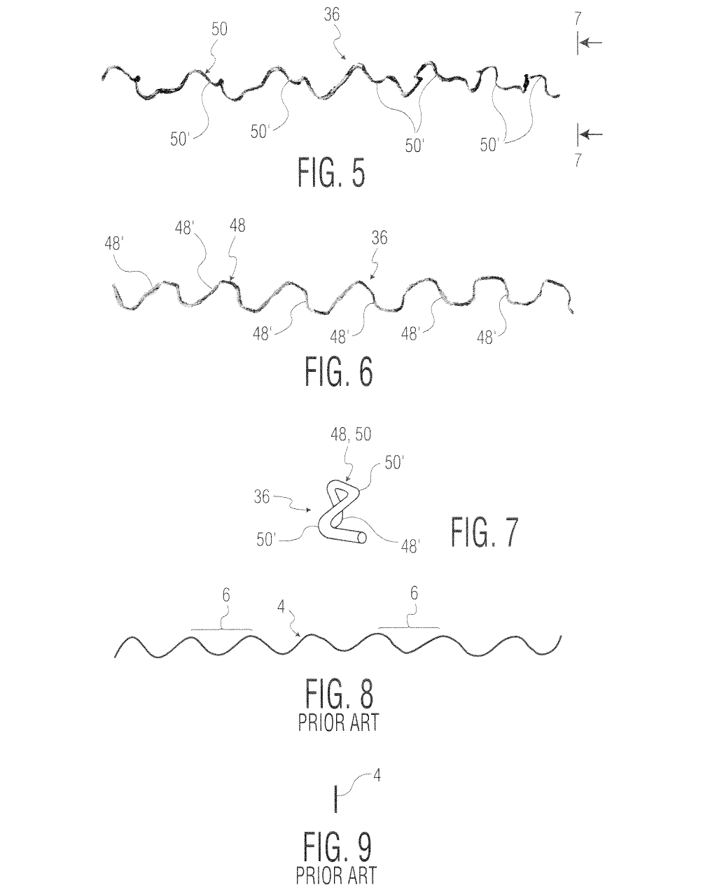

In FIGS. 3 and 4, novel filter 46 according to an embodiment of the present invention is shown. This filter has the same mass, weight and shape of the filter 2 of FIGS. 1 and 2. Filter 46 is formed of the inventive wire 36, FIGS. 5, 6 and 7 of substantially the same length of wire as the wire 4 of filter 2. The difference is the shape between the wire corrugations of prior art wire 4 and novel wire 36. As noted in the introductory portion, filter 46 comprising wire 36 is merely exemplary of other filters for use in air bags. Other filters for other different applications and/or of different dimensions and shapes for air bag implementation may also be formed with similar corrugated wire 36. The difference between the prior art filters such as filter 2 and filter 46 is that filter 46 is formed of the novel corrugated wire 36 according to an embodiment of the present invention.

In FIGS. 5, 6 and 7, wire 36 comprises two sets of corrugations 48 and 50. Each of the corrugations 48 and 50 comprise substantially sinusoidal waves which might be distorted somewhat due to the resiliency of the wires during formation. The corrugations 48 and 50 are formed orthogonal to one another. They also are of different pitches and amplitudes. The pitch and amplitude of the waves 48′ of corrugation 48 are identical. The pitch and amplitude of the waves 50′ of corrugation 50 are identical. As best seen in FIG. 7, the corrugations 48 and 50 form the wire 36 into a three dimensional shaped wire with the corrugations extending in a three dimensional space.

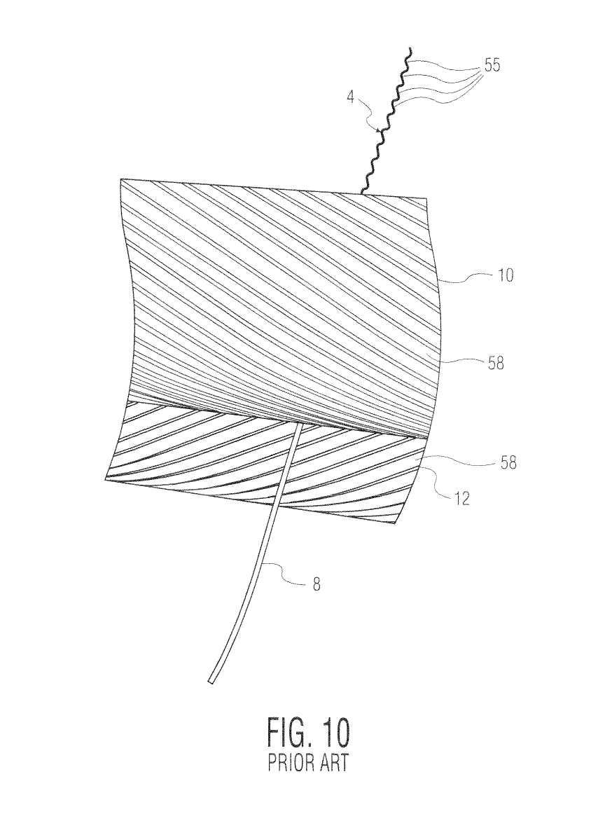

Such three dimensional shape of the wire 36 due to the orthogonal corrugations 48 and 50 is important as compared to the coplanar sinusoidal waves of the prior art filter 2, FIGS. 1 and 2. As the wire 36 is formed into a filter by overlying layers of a single continuous length of wire 36 as will be describe shortly, the three dimensional aspect of the waves of the overlying layers in the formed filter tend to interlock after compression into the final filter shape. This interlocking of the compressed wire layers precludes the tendency of the various layers to separate under tensile forces. This tendency to separate occurs with the prior art wire 4, FIG. 8, of the filter 2 comprising coplanar sinusoidal waves 6.

Because the pitches are different in the two waves 48′ and 50′ the shapes of the two different sets of orthogonal waves form a complex series or sequence of three dimensional waves as shown in FIGS. 5, 6 and 7. The waves 48′ and 50′ as combined are thus formed as a sequence in and of themselves. But when combined, the wave shapes in the combined sequences are complex and tend to contribute to the desired interlocking when placed in overlying compressed layers in forming the filter 46.

In FIG. 7, wire 36 exhibits the waves 48′ extending in the horizontal direction from left to right in the figure whereas the waves 50′ are oriented approximately relatively vertical in the figure. The waves 48′ preferably have a pitch in this embodiment of about 3.5 mm and an amplitude of about 2 mm. The waves 50′ preferably have a pitch in this embodiment of about 9 mm and an amplitude of about 5 mm. The wire 36 preferably is about 0.5 to about 0.7 mm diameter SS type 430 or type 304. For other types of filters the wires may be 0.1 mm to 0.25 mm diameter stainless steel (SS) type 304.

While the filter 46 of FIGS. 3 and 4 have a central bore, other filters may be solid cylindrical such as filter 52, FIG. 4a or spherical, such as filter 54, FIG. 4b. Both filters may comprise wire 36 or its equivalent (such as different wire gage and/or different pitches and amplitudes from that of wire 36. Such wire may be in one or more lengths of a continuous corrugated wire corresponding to wire 36, FIGS. 5, 6 and 7. Such filter shapes are formed merely by the shape of the compression die cavities and related die structures.

In FIG. 10, as discussed in the introductory portion, the prior art helically meshing grooved rollers 10 and 12 are used to form the wire 8. The wire 8 is formed with a sequence of coplanar sinusoidal waves 55 of equal amplitude and pitch of the dimensions noted previously. These dimensions are as determined by the dimensions of the pitches and depths of the corrugation grooves 58 in rollers 10 and 12. The pitch and amplitude of the waves 48′ and 50′ formed by rollers 10 and 12 are exemplary. The pitch can range from about 3 to about 14 mm for either of the corrugations forming waves 48′ and 50′. The values of the amplitudes of the waves can range from about 1 to about 10 mm for either of the corrugations. Other rollers, not shown, of different groove pitch and depth as discussed in the introductory portion, may be used according to a given implementation to form waves in a wire of corresponding pitch and amplitude.

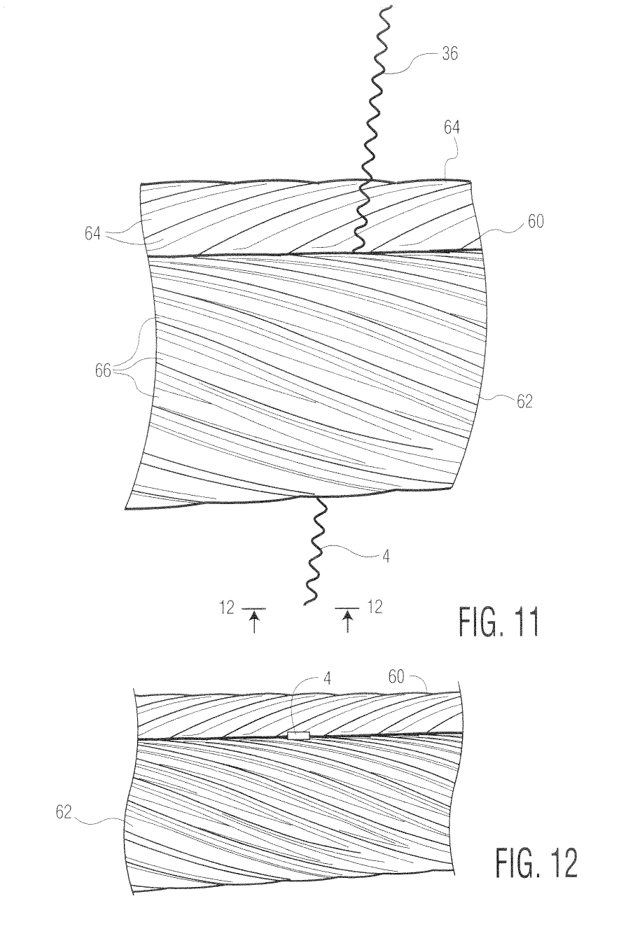

The so formed wire 4, FIG. 10, is then processed by a further set of two rollers 60 and 62, FIGS. 11 and 12. These rollers have respective meshing grooves 64 and 66, which grooves form the corrugation waves 48′ and 50′ in the wire 4 to create the wire 36 by rollers 60, 62. As shown in FIG. 12, the wire 4 is inserted between the rollers 60, 62 so that the waves 50′ formed by the corrugations created by grooves 64 of the two rollers are oriented orthogonal to the waves 48′ formed by the rollers 10, 12, FIG. 10.

The waves 48′ of the wire 36, FIG. 6, are preferably oriented about 90° to the waves 50′ of wire 36, FIG. 5, to obtain maximum interlocking of the different layers in the compressed final formed filter. Orientations other than the orthogonal transverse orientations of the two types of corrugations of waves 48′ and 50′, FIGS. 5 and 6, may be provided a wire for compression forming a filter according to a given implementation of that filter.

However, investigation of such other orientations has shown that as the two sets of corrugation waves move away from relative orthogonal orientations, the second corrugation tends to twist under compression during formation of the filter to align with the first corrugation. In a sense, the first corrugation is negated by the second corrugation during compression forming of the filter. The waves of the resulting layers then closely match the waves and thus function of a single corrugated wire corresponding to wire 4, FIG. 8, in the final compressed filter.

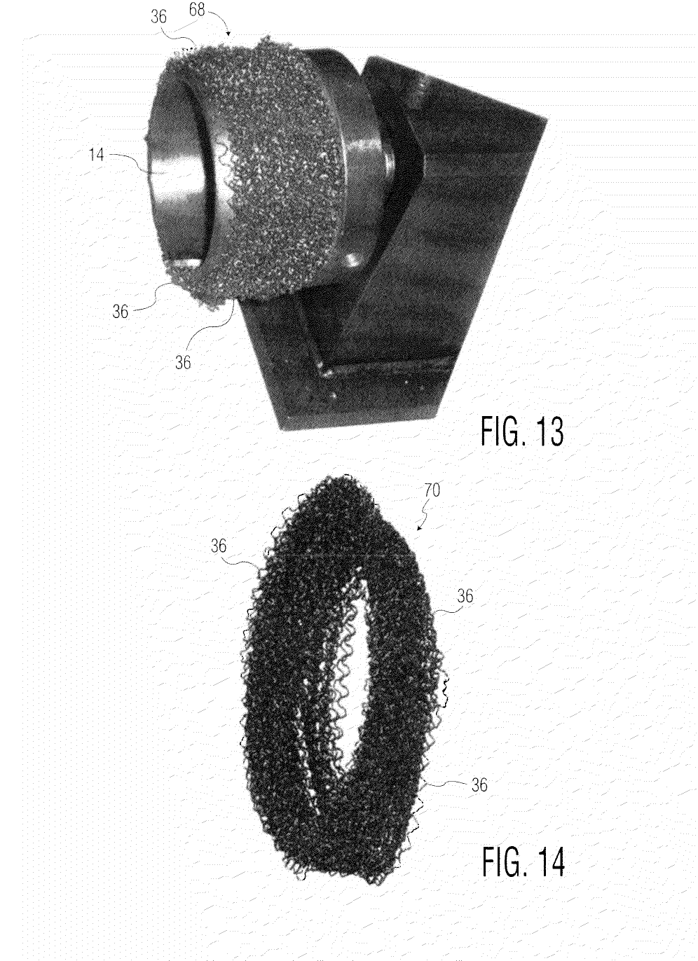

In FIG. 13, a given length of wire 36, determined by the desired mass of the end result filter, is wrapped about a circular cylindrical mandrel 14 of a desired diameter, e.g., 3.5 inches (8.9 cm) in a preferred embodiment as determined by the final filter design. This size can be different for different implementations depending upon the details of the final filter. The so wrapped wire 36, FIG. 13, forms a ring 68 of multiple layers of wire 36 (or multiple lengths of layered wires 36 according to a given implementation).

The ring 68 is then crushed into an oval 70, FIG. 14.

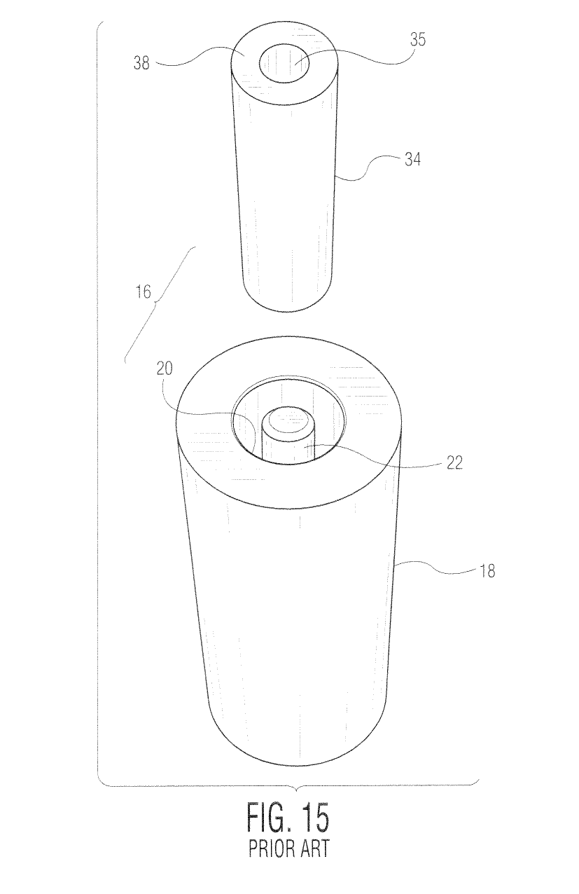

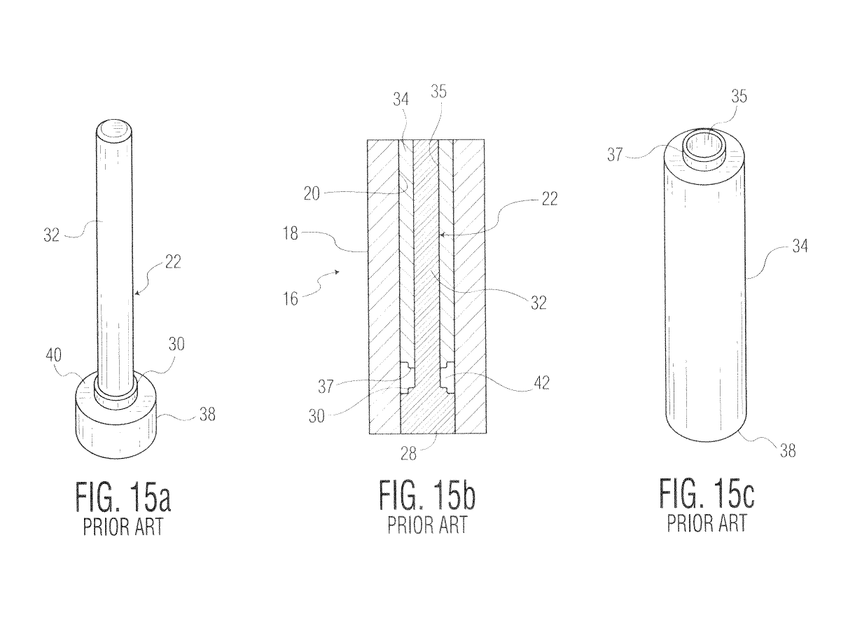

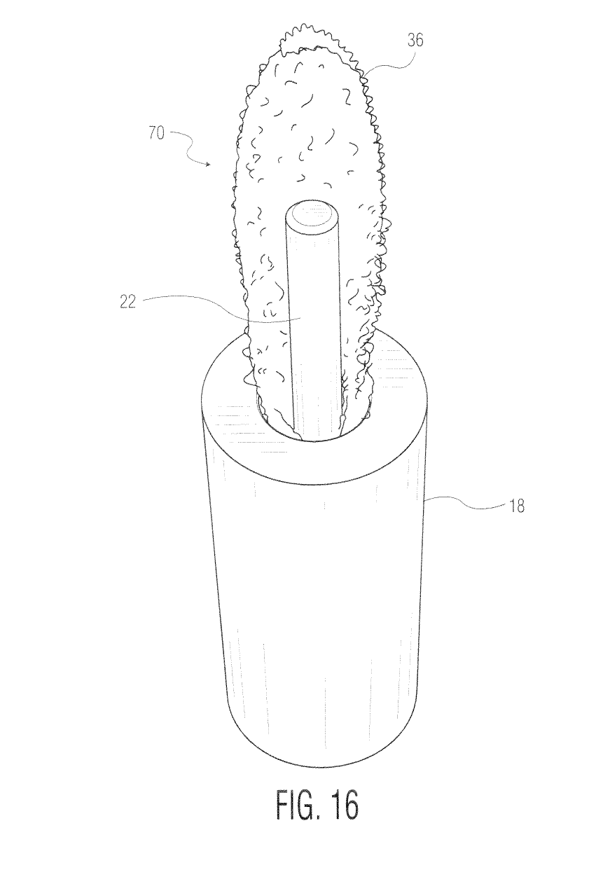

In FIGS. 15, 15a, 15b and 15c, a prior art tool 16 is shown. The tool is described in the introductory portion. The oval 70 of crushed wire 36 is inserted into the bore 20 of the compression die 18. FIG. 16, as the mandrel 22 is also inserted into the bore 20 at the same time. The oval is placed above the surface 40 of the mandrel 22 in the bore 20 and adjacent to the mandrel portion 32 in the bore 20. The plunger 34 is positioned as shown in FIG. 17. The plunger 34 is then inserted into the bore 20 of the die 18 with the mandrel portion 32 inserted into the bore 35 of the plunger. The plunger 34 is then forced into the bore 20 with a pressure of about 200 to 400 MPa. The filter 46 is formed by the shape of the cavity 42, FIG. 15b, determined by the mandrel 22 and plunger facing surfaces, and appears as shown in FIGS. 3 and 4.

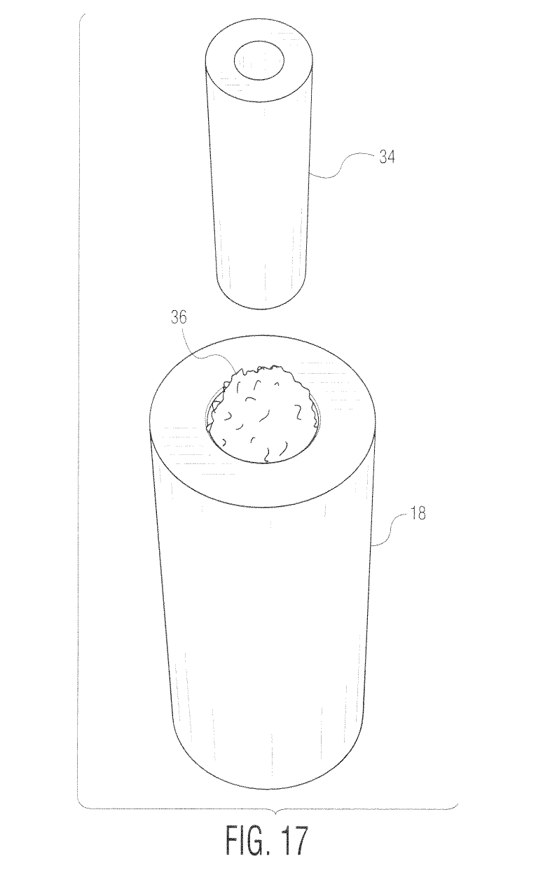

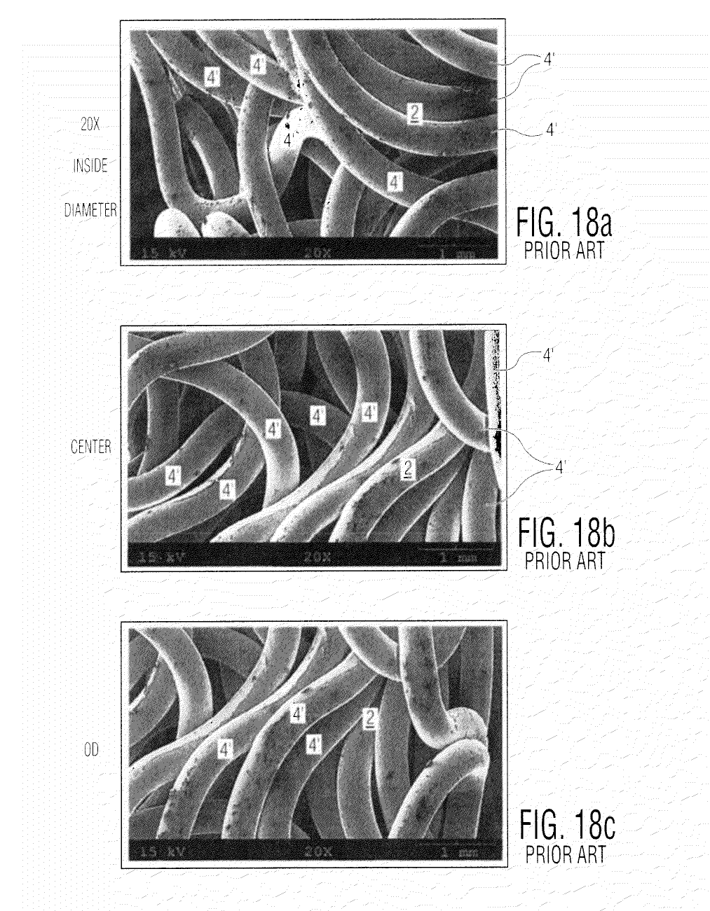

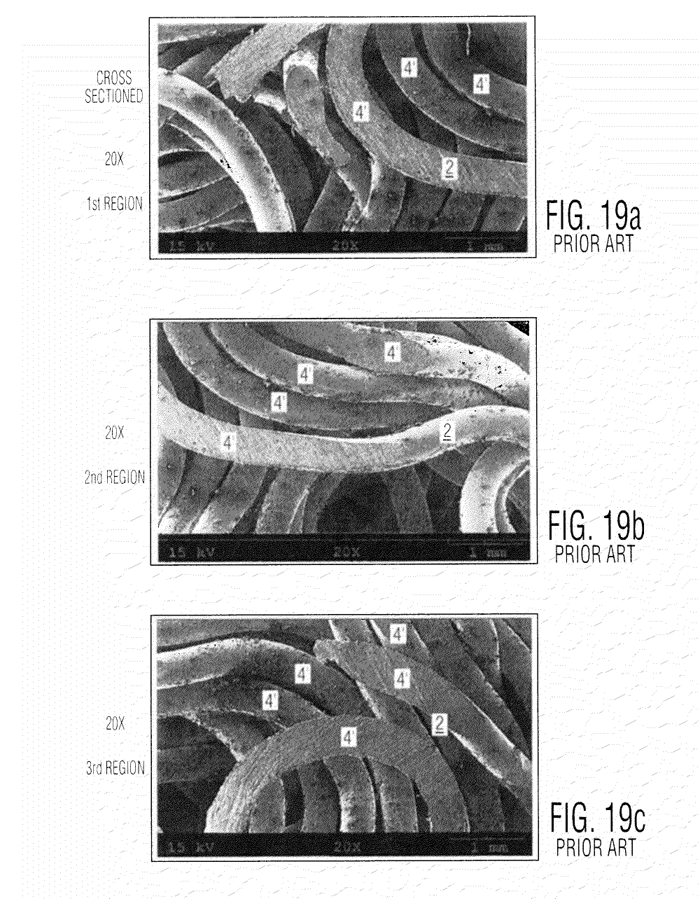

FIGS. 18a, 18b, and 18c are a photographs of a scanning electron microscope view at 20× magnification, of a filter such as filter 2 at an inside diameter, at the filter center and at the outside diameter. FIGS. 19a, 19b, and 19c are photographs of a scanning electron microscope view at 20× magnification, of a sectioned filter such as filter 2 taken at a sectioned surface at three different regions of the section surface. In these figures, the wires 4′ of the prior art filter 2 appear in their compressed final filter form as not being substantially interlocked. Instead they appear to be either parallel and/or layered, one over the other in manner consistent with the formation of the layers per FIG. 13 as discussed in the introductory portion. It has been observed with respect to filter 2, that manually pulling on the wires of the filter, the various layers of wires appear to easily separate. In contrast, pulling on corresponding layers of the wires of novel filter 46 fabricated according to the present invention, does not result in such separation.

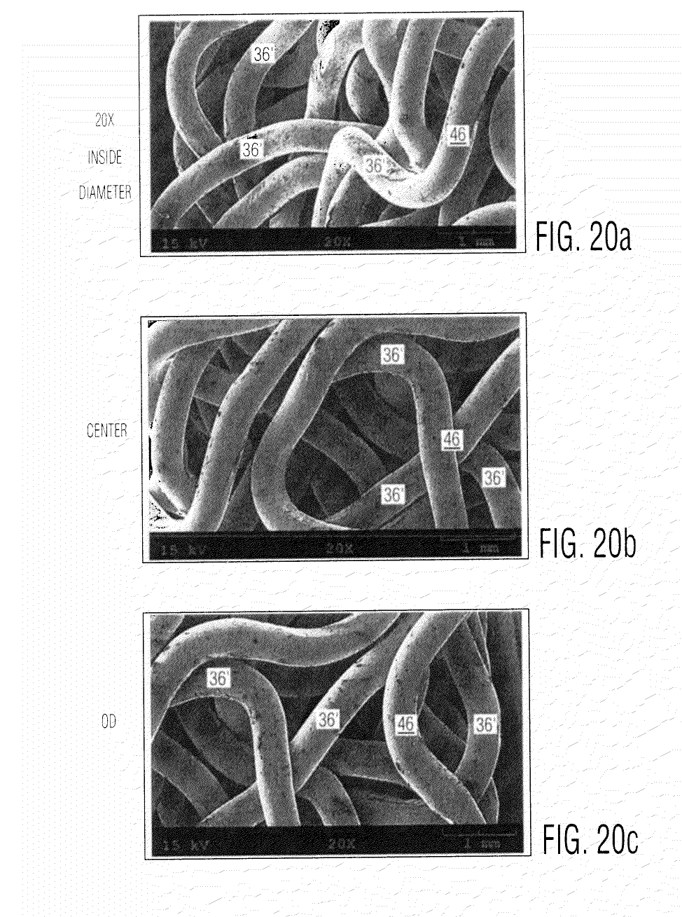

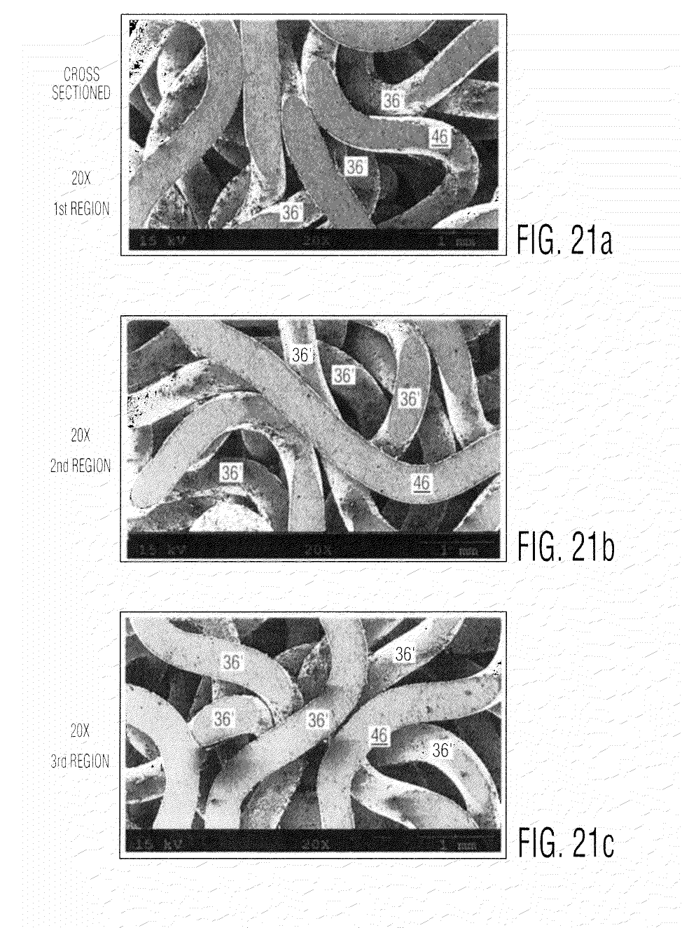

For example, FIGS. 20a, 20b and 20c are photographs of a scanning electron microscope view at 20× magnification of a filter fabricated according to an embodiment of the present invention, such as filter 46, at an inside diameter, at the filter center and at the outside diameter. FIGS. 21a, 21b, and 21c are photographs of a scanning electron microscope view at 20× magnification, of a sectioned filter according to an embodiment of the present invention, such as filter 46. In these figures, the novel inventive wires 44′ are fabricated according to FIGS. 5, 6 and 7.

The photos were taken at a sectioned surface at three different regions of the section surface. In these figures, the wires 36′ of a filter corresponding to novel filter 46 according to the present invention appear in their compressed final filter form as being substantially interlocked rather than either parallel and/or layered, one over the other as with the prior art filter 2, FIG. 18a through and including FIG. 19c. It has been observed with respect to filter 46, that manually pulling on the wires of the filter, the various layers do not easily separate. In contrast, the pulling on corresponding layers of the filter 2 fabricated according to the prior art as discussed above does result in easy separation of the layers of wire.

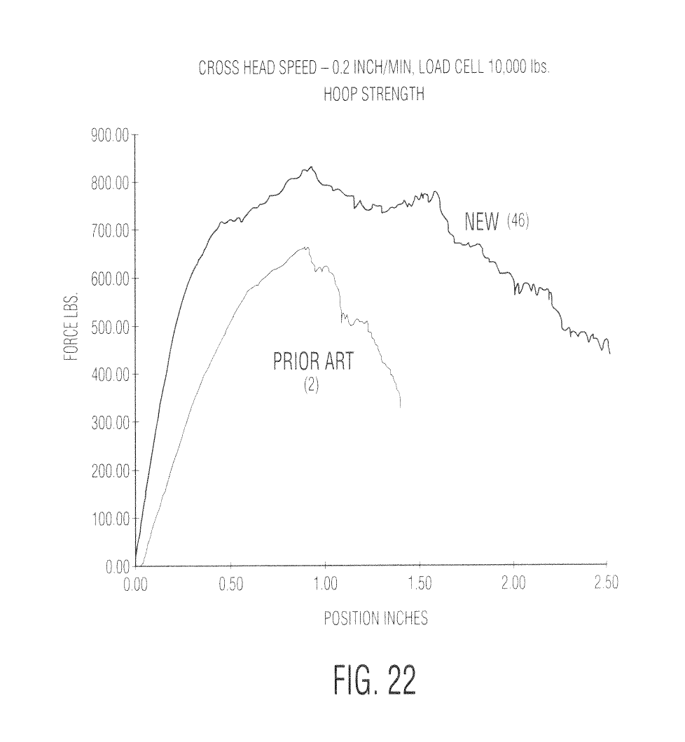

In FIG. 22, the increased hoop strength of the filter 46 fabricated with wires according to an embodiment of the present invention is shown to have a significant greater strength than the prior art filter 2, when tested with a load cell at 10,000 pounds at a cross head speed of 0.2 inches/minute, without any further enhancements to the filter to increase its hoop strength. Such enhancements are disclosed by the prior art such as U.S. Pat. No. 6,277,166 (added reinforcing ribs) and U.S. Pat. No. 7,559156 (added reinforcing peripheral wire) discussed in the introductory portion.

In further embodiments, two or more continuous corrugated wires 36 of the same or different lengths, may be wrapped about the mandrel 14, FIG. 13 in parallel. The important factor is the interlocking relationship of the corrugations in the final compressed filter which may be of any desired mass and dimensions. For example, the wire 36 or variations thereof that meet the interlocking requirement discussed above, may be any length, for example, from about 50 feet (about 15 m) (or less) to about 100 feet (30 m) or more or any number of wires wrapped in parallel about a mandrel to provide a given mass of wire.

The 10K LB. load cell of FIG. 22 is manufactured by United using low alloy steel pins.

While particular embodiments have been disclosed, it should be understood that such embodiments are given by way of example. Other embodiments formed by obvious variations of the disclosed embodiments may be created by those of ordinary skill. For example, wire size, material type, wave pitches and amplitudes, mass of wire used, number of wires used, shape of the waves other than sinusoidal and so on including pressures, dimensions and values given may be employed within the scope of the present invention. As mentioned in the introductory portion, the rollers forming the corrugation waves may be meshed and it does not matter if their grooves are helical or parallel. It is intended that the scope of the invention be defined by the appended claims, the description herein being given by way of illustration and not limitation.

What is claimed is:

1. A length of metal wire for forming a compressed wire mesh annular filter, comprising:
a first sequence of undulations extending along the wire length in a given direction generally lying in a first given plane; and
a second sequence of undulations extending along the wire length in the given direction generally lying in a second given plane transverse the first given plane;
the wire for being wrapped about itself to form a ring which, when shaped and compressed, forms the filter with contiguous adjacent compressed undulations, the compressed undulations, being distorted from their respective planes, tending to interlock to thereby preclude separation of adjacent wires that might otherwise occur in response to an applied load.

2. The wire of claim 1 wherein the undulations comprise substantially sinusoidal waves.

3. The wire of claim 1 wherein the first and second sequence of undulations are approximately orthogonal to each other.

4. The wire of claim 1 wherein the pitch of the first sequence of undulations of about 3.5 mm and an amplitude of about 2 mm and the second sequence has a pitch of about 9 mm and an amplitude of about 5 mm, the undulations forming sinusoidal waves, with the first and second sequences being approximately orthogonal to each other.

5. The wire of claim 1 wherein the undulations are sinusoidal and the pitch of the undulations range from about 3 to about 14 mm for either the first or second sequences and the amplitude of the undulations range from about 1 to 10 mm for either the first or second sequences.

6. The wires of claim 1 wherein the wires range from about 0.25 mm to about 1 mm diameter of at least one of stainless steel or carbon steel.

7. A filter formed with the wire of claim 1.

8. The filter of claim 7 wherein the wires are wrapped about one another to form an annular filter with adjacent undulations and at least a portion of the adjacent undulations are interlocked.

9. The filter of claim 7 being formed of the wire wrapped about itself forming multiple layers of crushed compressed wire.

10. The filter of claim 7 wherein the wire is one piece of a continuous length.

11. The filter of claim 7 comprising a plurality of said one piece continuous length wire.

12. The filter of claim 7 wherein the filter is a cylinder with an interior cylindrical bore, the cylinder having an outside diameter (OD) in the range of about 18 mm to about 70 mm, an interior bore having a diameter (ID) in the range of about 12 mm to about 60 mm and a height of about a 25 mm to about 50 mm.

13. The filter of claim 7 wherein the filter is a solid sphere of about 14 mm diameter and a solid cylinder of about 15 mm outside diameter and 10 mm in height.

14. A method of making the wire of claim 1 comprising passing a length of said wire in a first orientation between a first of two rotating rollers with meshing grooves to form the wire with the first sequence of undulations in substantially a first plane, rotating the length of wire to a second orientation, passing the rotated length of said wire in the second orientation between two further rotating rollers with meshing grooves to form the wire with the second sequence of undulations transverse to the first sequence of undulations.

15. The method of claim 14 wherein the grooves of the first and further rollers have different pitches and depths to form the undulations with corresponding different pitches and amplitudes.

16. The method of claim 14 wherein the pitch of the undulations range from about 3 to about 14 mm for either the first or further rollers and the amplitude of the undulations range from about 1 to about 10 mm for either the first or further rollers.

17. The method of claim 14 wherein the undulations are sinusoidal and wherein the pitch and amplitudes of the first rollers differ from that of the further rollers.

18. The method of claim 14 wherein the undulations are sinusoidal and the pitch of the undulations range from about 3 to about 14 mm for either the first or second sequences and the amplitude of the undulations range from about 1 to about 10 mm for either the first or second sequences.

19. The method of claim 14 wherein the filter is one of a hollow cylinder with a central bore, a solid cylinder or a solid sphere.

20. The method of claim 14 wherein the second orientation is orthogonal to the first orientation.

21. The method of making the filter of claim 7 comprising wrapping a continuous one piece length of the wire about a mandrel to form a ring of multiple layers of the wire, inserting the ring into a die, and compressing the ring to form the filter.

22. The method of claim 20 comprising forming the filter of a plurality of said length of wire.

23. The wire of claim 1 wherein the wire comprises a plurality of undulations extending in a first plane and extending in a second plane normal to the first plane.
